(19) United States
(12) Patent Application Publication
(10) Pub. No.: US 2020/0356642 A1
(43) Pub. Date: Nov. 12, 2020

(54) ENABLING AN ENCRYPTED SOFTWARE MODULE IN A CONTAINER FILE

(71) Applicant: ASSA ABLOY AB, Stockholm (SE)

(72) Inventors: Jonas KNUTSSON, Malmö (SE); Olof SANDBERG, Lund (SE)

(21) Appl. No.: 16/960,853

(22) PCT Filed: Jan. 31, 2019
(86) PCT No.: PCT/EP2019/052323

§ 371 Date: Jul. 8, 2020

(30) Foreign Application Priority Data
Jan. 31, 2018 (EP) 18154425.5

(51) Int. Cl. G06F 21/14; H04L 9/14

(52) U.S. Cl. CPC G06F 21/14; G06F 2221/0755; H04L 9/14

(57) ABSTRACT

It is provided a method for enabling an encrypted software module in a container file for a software application. The method is performed in a module provider and comprises the steps of: obtaining a software module; obtaining a module key based on an identifier of the software module and on a master key, the master key being used to generate a plurality of module keys in combination with respective identifiers of software modules; encrypting the software module using the module key, yielding an encrypted software module; and including the encrypted software module in a container file while omitting the module key from the container file, and omitting, from the container file, information that could be used to generate the module key.

### TECHNICAL FIELD

The invention relates to methods, a module provider, a computer device, computer programs and computer program products for enabling an encrypted software module in a container file for a software application.

### BACKGROUND

When a software application, also known as app, is distributed for a Google Android environment, this forms part of an Android Package Kit (APK). The APK is a container file which contains a number of files, including Java .class files. The APK is distributed to allow the app to be installed, and is thus available to a large number of people. Due to the Java structure, Java .class files can be decompiled to source .java files, thus revealing the logic and algorithms of the app.

This public availability of the source .java files is sometimes inconvenient and sometimes simply unacceptable, e.g. revealing trade secrets.

Obfuscation is a technique which can be used to complicate the decompilation of e.g. Java .class files. The original source file is passed through the obfuscator which creates a complicated and intricate structure of java source files. The obfuscated files are then compiled to bytecode. However, while obfuscation can be used to make it more difficult to understand the logic of source .java files based on the decompiled .class files, it is still possible with time and effort to learn a lot about how the source .java files function.

EP 3 057 019 A1 discloses an application comprising a code part being protected in a device including a processor that encrypts the code part to be protected to obtain a protected part using an encryption key, replaces the code part to be protected by valid instructions different from the code part to be protected, stores information necessary for decryption of the protected part so that the information may be retrieved by an unprotection function, stores the unprotection function so that the unprotection function can be called by a calling function, and inserts calls to the unprotection function and a protection function around a call to the code part to be protected in the application, the protection function being configured to protect the code part. When executed, a call to the unprotection function decrypts the protected part which is written over the valid instructions where it is executed. However, in this solution, the resulting DEX file contains both the encrypted module, a native library for decrypting as well as information and credential seeds to decrypt the encrypted module. This is a security risk since an attacker has all the data and methods in the DEX file and only needs to find out the structure of the content of the DEX file in order to decrypt the encrypted module.

### SUMMARY

It is an object to provide a way to include compiled java files in a container file, such as the APK, in a more secure way than in the prior art.

According to a first aspect, it is provided a method for enabling an encrypted software module in a container file for a software application. The method is performed in a module provider and comprises the steps of: obtaining a software module; obtaining a module key based on an identifier of the software module and on a master key, the master key being used to generate a plurality of module keys in combination with respective identifiers of software modules; encrypting the software module using the module key, yielding an encrypted software module; and including the encrypted software module in a container file while omitting the module key from the container file, and omitting, from the container file, information that could be used to generate the module key.

The software module may comprise a java .class file.

The identifier of the software module may be based on an identifier of the software application and a version indicator of the software application. The step of obtaining the module key may comprise generating the module key based on the identifier of the software module and the master key.

According to a second aspect, it is provided a module provider for enabling an encrypted software module in a container file for a software application. The module provider comprises: a processor; and a memory storing instructions that, when executed by the processor, cause the module provider to: obtain a software module; obtain a module key based on an identifier of the software module and on a master key, the master key being used to generate a plurality of module keys in combination with respective identifiers of software modules; encrypt the software module using the module key, yielding an encrypted software module; and include the encrypted software module in a container file while omitting the module key from the container file, and omitting, from the container file, information that could be used to generate the module key.

The software module may comprise a java .class file.

The identifier of the software module may be based on an identifier of the software application and a version indicator of the software application.

The instructions to obtain the module key may comprise instructions that, when executed by the processor, cause the module provider to generate the module key based on the identifier of the software module and the master key.

According to a third aspect, it is provided a computer program for enabling an encrypted software module in a container file for a software application. The computer program comprises computer program code which, when run on a module provider causes the module provider to: obtain a software module; obtain a module key based on an identifier of the software module and on a master key, the master key being used to generate a plurality of module keys in combination with respective identifiers of software modules; encrypt the software module using the module key, yielding an encrypted software module; and include the encrypted software module in a container file while omitting the module key from the container file, and omitting, from the container file, information that could be used to generate the module key.

According to a fourth aspect, it is provided a computer program product comprising a computer program according to the third aspect and a computer readable means on which the computer program is stored.

According to a fifth aspect, it is provided a method for enabling an encrypted software module in a container file for a software application. The method is performed in a computer device and comprises the steps of: obtaining an encrypted software module from a container file; transmitting a key request to a key provider, the key request comprising an identifier of the encrypted software module; receiving a module key from the key provider; decrypting the encrypted software module, yielding a decrypted software module; and loading the decrypted software module from restricted access memory of the computer device to enable its execution.

The method may further comprise the step of: encrypting the module key using an initiation sequence, yielding an encrypted module key; and storing the encrypted module key and the initiation sequence. In such a case, the step of decrypting the encrypted software module comprises decrypting the encrypted module key.

According to a sixth aspect, it is provided a computer device for enabling an encrypted software module in a container file for a software application. The computer device comprises: a processor; and a memory storing instructions that, when executed by the processor, cause the computer device to: obtain an encrypted software module from a container file; transmit a key request to a key provider, the key request comprising an identifier of the encrypted software module; receive a module key from the key provider; decrypt the encrypted software module, yielding a decrypted software module; and load the decrypted software module from restricted access memory of the computer device to enable its execution.

The computer device may further comprise instructions that, when executed by the processor, cause the computer device to: encrypt the module key using an initiation sequence, yielding an encrypted module key; and store the encrypted module key and the initiation sequence. In such a case, the instructions to decrypt comprise instructions that, when executed by the processor, cause the computer device to decrypt the encrypted module key.

According to a seventh aspect, it is provided a computer program for enabling an encrypted software module in a container file for a software application. The computer program comprises computer program code which, when run on a computer device causes the computer device to: obtain an encrypted software module from a container file; transmit a key request to a key provider, the key request comprising an identifier of the encrypted software module; receive a module key from the key provider; decrypt the encrypted software module, yielding a decrypted software module; and load the decrypted software module from restricted access memory of the computer device to enable its execution.

According to an eighth aspect, it is provided a computer program product comprising a computer program according to the seventh aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating how a container file for a software application is populated with an encrypted software module;

FIG. 2 is a schematic diagram illustrating how the container file for the app is used and how its encrypted software module is decrypted;

FIG. 3 is a flow chart illustrating a method for including an encrypted module in a container file for a software application;

FIG. 4 is a flow chart illustrating a method for enabling execution of software module of a container file for a software application;

FIG. 5 is a schematic diagram illustrating components forming part of both the computer device and the module provider of FIGS. 1-2; and

FIG. 6 shows one example of a computer program product 90 comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

Embodiments presented herein are based on encryption with separate key distribution. The software module is encrypted at build-time and the encrypted software module is included in the container file. At run-time, a key is obtained by the executing computer device, to thereby decrypt the software module. The decrypted software module can then be loaded for execution. In this way, the container file is safe, containing only the software module in encrypted form and no key. Moreover, the decrypted software module can be kept from being stored outside restricted access memory of the computer device, further complicating for an attacker to decompile the software module. In other words, embodiments presented herein are based on cryptography and run-time decryption of the encrypted software module.

It is to be noted that while embodiments presented herein are illustrated as part of a java architecture for Google Android, the embodiments can equally well be applied in other software architectures.

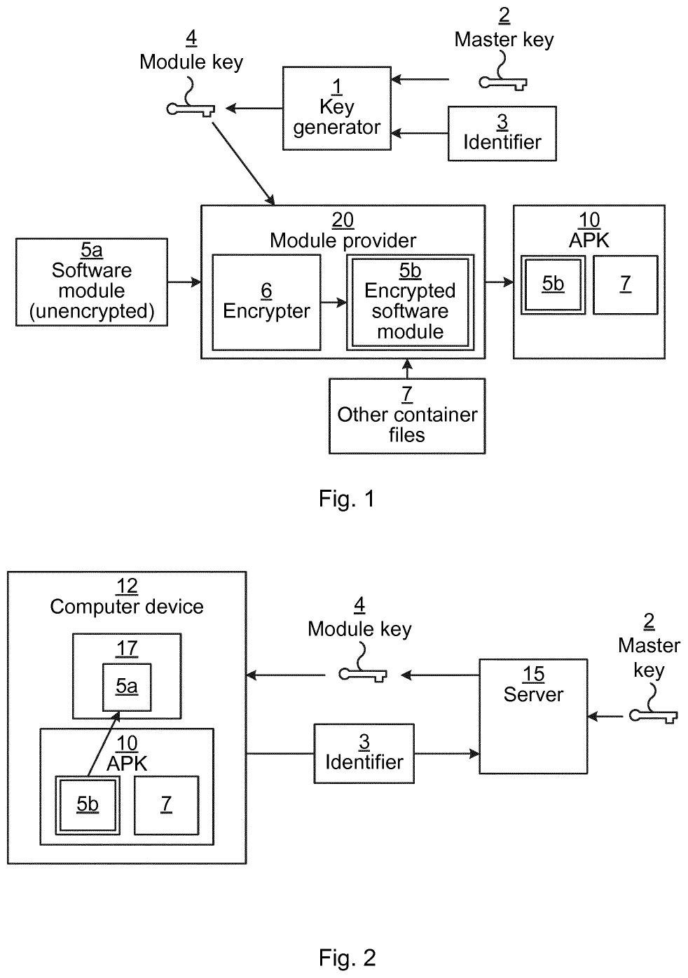

FIG. 1 is a schematic diagram illustrating how a container file 10 for a software application (also known as app) is populated with an encrypted software module 5b. FIG. 1 illustrates actions at build-time, i.e. when the container file is generated, prior to distribution of the container file 10. A software module 5a contains code that is desired to be kept secret. For instance, the software module 5a might contain logic that forms part of a trade secret. The software module 5a contains compiled computer executable code, which can be machine code or bytecode such as one or more java .class files.

A key generator 1 generates a module key 4 to be used for encrypting the software module 5a. The module key 4 is generated based on a master key 2 and an identifier 3. The identifier 3 is associated with the software module 5a, whereby also the module key 4 is associated with the software module 5a. For instance, the identifier can be based on the name of the app and its version indicator. Alternatively, the identifier can be based on the name of the software module 5a and its version indicator. The master key is used to generate a plurality of module keys in combination with respective identifiers of software modules. Using the key generator 1 to generate the module key 4 avoids having to distribute the master key 2 to the module provider 20 or the subsequent computer device executing the container file 10. This improves security of the master key 2.

A module provider 20 takes the software module 5a and the module key 4 as input and, in an encrypter 6, encrypts the software module 5a, yielding an encrypted software module 5b. The encrypter is a software and/or hardware module within the module provider 20. The module provider 20 takes other container files 7 as input and generates the container file 10 comprising both the encrypted software module 5b and the other container files 7. Significantly, the container file 10 does not contain the module key 4.

The other container files 7 are files known in the art per se to form part of the container file 10. For instance, the other container files 7 can contain non-encrypted software modules, manifest file, media files (images, sounds, etc.). In this example, the container file 10 is an APK (Android Package Kit).

The container file 10 now only contains the software module (which is desired to keep secret) as an encrypted software module 5b and is thus safe to be distributed. If an attacker takes the container file 10 and tries to decrypt the encrypted software module 5b, this would be extremely difficult.

It is to be noted that the module provider 20 can form part of a larger device, such as a deployment server or build server, which optionally also comprises the key generator 1 and capabilities to generate the other container files 7.

FIG. 2 is a schematic diagram illustrating how the container file for the app is used and how its encrypted software module 5b is decrypted. FIG. 2 illustrates actions at run-time, i.e. when the container file 10 is used to execute the app.

A computer device 12 is capable of executing apps. The computer device 12 can e.g. be in the form of a smartphone, tablet computer, smart watch, etc. running a Google Android operating system. The computer device 12 has access to the container file 10, e.g. by the user installing the container file 10 on the computer device 12.

When the container file 10 is executed, the other container files 7 contain (unencrypted) software which causes the computer device 12 to send a request to a server 15 for a module key 4. The request comprises an identifier 3 which is identical to the identifier used to generate the module key 4 at build-time, which module key 4 was used to encrypt the software module. The server 15 has access to the master key 2, which is the same master key 2 used by the key generator 1 at build-time. The server 15 generates the module key 4 in the same way that the key generator 1 generated the module key 4 at build-time. Hence, the module key 4 generated by the server 15 is identical to the module key 4 used for encryption at build-time. The server 15 then sends the module key 4 to the computer device 12 requesting it.

Once the module key 4 has been received by the computer device 12, it decrypts the encrypted software module 5b, yielding the decrypted software module 5a. The decrypted software module 5a is only stored in restricted access memory 17 to reduce the risk of an attacker gaining access to the decrypted software module 5a. Once decrypted, the computer device 12 can load the decrypted software module 5a (or more specifically its class file(s)) dynamically to enable execution of the decrypted software module 5a.

Communication between the different entities in FIG. 1 and FIG. 2 can e.g. occur using Internet Protocol (IP) over wireless or wired connections, e.g. any of the IEEE 802.11x standards or Ethernet.

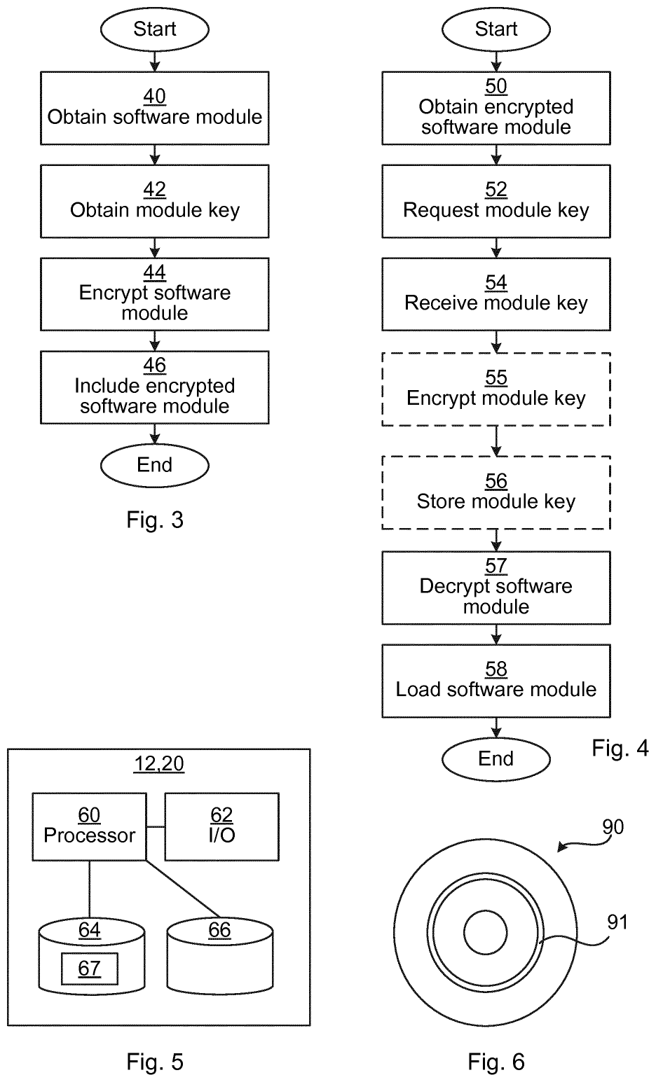

FIG. 3 is a flow chart illustrating a method for including an encrypted module in a container file for a software application, i.e. an app. The method is performed in the module provider 20 of FIG. 1 to thereby enable an encrypted software module in the container file for the app. As explained above, the software module can comprise one ore more java .class files.

In an obtain software module step 40, the module provider obtains a software module, which is the software module which is to be encrypted. The software module contains compiled executable code.

In an obtain module key step 42, the module provider obtains a module key based on an identifier of the software module and on a master key. The master key is used to generate a plurality of module keys in combination with respective identifiers of software modules. This step can comprise generating the module key based on the identifier of the software module and the master key. The identifier of the software module can e.g. be based on an identifier of the app and a version indicator of the app. Alternatively, the identifier can be based on the name of the software module 5a and its version indicator. The module key is generated based on the identifier and the master key. This generation can occur in the module provider or in an external key generator (see e.g. FIG. 1 and corresponding description above).

In an encrypt software module step 44, the module provider encrypts the software module using the module key. The encryption yields an encrypted software module. The encryption can be based on symmetric key cryptography.

In an include encrypted software module step 46, the module provider includes the encrypted software module in a container file while omitting the module key from the container file. Furthermore, information that could be used to generate the module key is omitted from the container file. In other words, the encrypted software module, but not the module key (nor information for generating the module key), is included in the container file. The container file can include other unencrypted and/or encrypted class files and other files (such as a manifest file and media files) as known in the art per se.

The resulting container file thus contains the software module in encrypted form, whereby it is extremely difficult for an attacker to decrypt the software module.

FIG. 4 is a flow chart illustrating a method for enabling execution of software module of a container file for an app. The method is performed in the computer device of FIG. 2 to thereby enable the encrypted software module in a container file for the app. The computer device can be based on a Google Android architecture. The method steps below can be performed by unencrypted software forming part of the container file.

In an obtain encrypted software module step 50, the computer device obtains an encrypted software module from a container file. The container file can be an APK installed on the computer device.

In a request module key step 52, the computer device transmits a key request over a network connection to a remote key provider, such as the server 15 of FIG. 2. Significantly, the key request is not a local request to the computer device itself, as this would require decryption data to be locally stored, which would be a significant security risk. The network connection can be a wireless and/or a wire-based connection such as any combination of one or more of WiFi (IEEE 802.11x), Bluetooth, cellular connection (2G, 3G, 4G, 5G), Ethernet, fibre connection etc., upon which an IP (Internet Protocol) connection can be established between the computer device and the remote key provider. The term remote is here to be interpreted as being in a different location than the computer device, e.g. more than 10 metres away. The key request comprises an identifier of the encrypted software module. The identifier is the same as the identifier used in step 42 and explained above. Optionally, the request is only sent to the key provider after the server has authenticated itself, to prevent unauthorised parties receiving or detecting the key request.

In a receive module key step 54, the computer device receives a module key from the key provider.

In an optional encrypt module key step 55, the computer device encrypts the module key using an initiation sequence, yielding an encrypted module key. This step can e.g. use Android Keystore.

In an optional store module key step 56, the computer device stores the encrypted module key and the initiation sequence.

In a decrypt software module step 57, the computer device decrypts the encrypted software module, yielding a decrypted software module. When the module key is encrypted, this step comprises first decrypting the encrypted module key, e.g. using Android Keystore. For the decryption, the encrypted module key is provided along with the initiation sequence. Once the decrypted software module is obtained, this can be stored in restricted access memory either on file or kept in RAM as a byte array.

In a load software module step 58, the computer device loads the decrypted software module from restricted access memory of the computer device to enable its execution, e.g. from file or from RAM as a byte array. The decrypted software module is only stored in restricted access memory. In this way, it is significantly more difficult for an attacker to obtain access to the decrypted software module.

The provided solution allows distribution of a container file containing an encrypted software module. The software module is only decrypted at run-time, whereby it is extremely difficult for an attacker to figure out the logic and functionality of the software module.

FIG. 5 is a schematic diagram illustrating components forming part of both the computer device 12 and the module provider 20 of FIGS. 1-2. A processor 60 is provided using any combination of one or more of a suitable central processing unit (CPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the methods described with reference to FIGS. 3 and 4 above.

The memory 64 can be any combination of random-access memory (RAM) and optionally read only memory (ROM). The memory 64 also comprises persistent storage, which, for example, can be any single one or combination of magnetic memory, optical memory, solid-state memory or even remotely mounted memory. Part of the memory is restricted access memory. For instance, the restricted access memory can be the sandbox available only to the app. The restricted access memory is used to store decrypted software modules. The restricted memory could also form part of RAM.

A data memory 66 is also provided for reading and/or storing data during execution of software instructions in the processor 60. The data memory 66 can e.g. be implemented using RAM.

The computer device 12 and module provider 20 further comprises an I/O interface 62 for communicating with other external entities.

Other components of the computer device 12 and the module provider 20 are omitted in order not to obscure the concepts presented herein.

FIG. 6 shows one example of a computer program product 90 comprising computer readable means. On this computer readable means, a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 64 of FIG. 5. While the computer program 91 is here schematically shown as a track on the depicted optical disk, the computer program can be stored in any way which is suitable for the computer program product, such as a removable solid state memory, e.g. a Universal Serial Bus (USB) drive.

Here now follows a list of embodiments from another perspective, enumerated with roman numerals.

i. A method for enabling an encrypted software module in a container file for a software application, the method being performed in a module provider and comprising the steps of:
obtaining a software module;
obtaining a module key based on an identifier of the software module and on a master key;
encrypting the software module using the module key, yielding an encrypted software module; and
including the encrypted software module in a container file while omitting the module key from the container file.

ii. The method according to embodiment i, wherein the software module comprises a java .class file.

iii. The method accruing to embodiment i or ii, wherein the identifier of the software module is based on an identifier of the software application and a version indicator of the software application.

iv. A module provider for enabling an encrypted software module in a container file for a software application, the module provider comprising:
a processor; and
a memory storing instructions that, when executed by the processor, cause the module provider to:
obtain a software module;
obtain a module key based on an identifier of the software module and on a master key;
encrypt the software module using the module key, yielding an encrypted software module; and
include the encrypted software module in a container file while omitting the module key from the container file.

v. The module provider according to embodiment iv, wherein the software module comprises a java .class file.

vi. The module provider accruing to embodiment iv or v, wherein the identifier of the software module is based on an identifier of the software application and a version indicator of the software application.

vii. A computer program for enabling an encrypted software module in a container file for a software application, the computer program comprising computer program code which, when run on a module provider causes the module provider to:
obtain a software module;
obtain a module key based on an identifier of the software module and on a master key;
encrypt the software module using the module key, yielding an encrypted software module; and
include the encrypted software module in a container file while omitting the module key from the container file.

viii. A computer program product comprising a computer program according to embodiment vii and a computer readable means on which the computer program is stored.

ix. A method for enabling an encrypted software module in a container file for a software application, the method being performed in a computer device and comprising the steps of:
obtaining an encrypted software module from a container file;
transmitting a key request to a key provider, the key request comprising an identifier of the encrypted software module;
receiving a module key from the key provider;
decrypting the encrypted software module, yielding a decrypted software module; and
loading the decrypted software module from restricted access memory of the computer device to enable its execution.

x. The method according to embodiment ix, further comprising the step of:
encrypting the module key using an initiation sequence, yielding an encrypted module key; and
storing the encrypted module key and the initiation sequence;
wherein the step of decrypting the encrypted software module comprises decrypting the encrypted module key.

xi. A computer device for enabling an encrypted software module in a container file for a software application, the computer device comprising:
a processor; and
a memory storing instructions that, when executed by the processor, cause the computer device to:
obtain an encrypted software module from a container file;
transmit a key request to a key provider, the key request comprising an identifier of the encrypted software module;
receive a module key from the key provider;
decrypt the encrypted software module, yielding a decrypted software module; and
load the decrypted software module from restricted access memory of the computer device to enable its execution.

xii. The computer device according to embodiment xi, further comprising instructions that, when executed by the processor, cause the computer device to:
encrypt the module key using an initiation sequence, yielding an encrypted module key; and
store the encrypted module key and the initiation sequence;
wherein the instructions to decrypt comprise instructions that, when executed by the processor, cause the computer device to decrypt the encrypted module key.

xiii. A computer program for enabling an encrypted software module in a container file for a software application, the computer program comprising computer program code which, when run on a computer device causes the computer device to:
obtain an encrypted software module from a container file;
transmit a key request to a key provider, the key request comprising an identifier of the encrypted software module;
receive a module key from the key provider;
decrypt the encrypted software module, yielding a decrypted software module; and
load the decrypted software module from restricted access memory of the computer device to enable its execution.

xiv. A computer program product comprising a computer program according to embodiment xiii and a computer readable means on which the computer program is stored.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for enabling an encrypted software module in a container file for a software application, the method being performed in a module provider and comprising:
obtaining a software module;
obtaining a module key based on an identifier of the software module and on a master key, the master key being used to generate a plurality of module keys in combination with respective identifiers of software modules;
encrypting the software module using the module key, yielding an encrypted software module; and
including the encrypted software module in a container file while omitting the module key from the container file, and omitting, from the container file, information that could be used to generate the module key.

2. The method according to claim 1, wherein the software module comprises a java .class file.

3. The method according to claim 1, wherein the identifier of the software module is based on an identifier of the software application and a version indicator of the software application.

4. The method according to claim 1, wherein the step of obtaining the module key comprises generating the module key based on the identifier of the software module and the master key.

5. A module provider for enabling an encrypted software module in a container file for a software application, the module provider comprising:
a processor; and
a memory storing instructions that, when executed by the processor, cause the module provider to:
obtain a software module;
obtain a module key based on an identifier of the software module and on a master key, the master key being used to generate a plurality of module keys in combination with respective identifiers of software modules;
encrypt the software module using the module key, yielding an encrypted software module; and
include the encrypted software module in a container file while omitting the module key from the container file, and omitting, from the container file, information that could be used to generate the module key.

6. The module provider according to claim 5, wherein the software module comprises a java .class file.

7. The module provider according to claim 5, wherein the identifier of the software module is based on an identifier of the software application and a version indicator of the software application.

8. The module provider according to claim 5, wherein the instructions to obtain the module key comprise instructions that, when executed by the processor, cause the module provider to generate the module key based on the identifier of the software module and the master key.

9. A computer program for enabling an encrypted software module in a container file for a software application, the computer program comprising computer program code which, when run on a module provider causes the module provider to:
obtain a software module;
obtain a module key based on an identifier of the software module and on a master key, the master key being used to generate a plurality of module keys in combination with respective identifiers of software modules;
encrypt the software module using the module key, yielding an encrypted software module; and
include the encrypted software module in a container file while omitting the module key from the container file, and omitting, from the container file, information that could be used to generate the module key.

10. A computer program product comprising a computer program according to claim 9 and a computer readable means on which the computer program is stored.

11. A method for enabling an encrypted software module in a container file for a software application, the method being performed in a computer device and comprising:
obtaining an encrypted software module from a container file;
transmitting a key request over a network connection to a remote key provider, the key request comprising an identifier of the encrypted software module;
receiving a module key from the key provider;
decrypting the encrypted software module, yielding a decrypted software module; and
loading the decrypted software module from restricted access memory of the computer device to enable its execution.

12. The method according to claim 11, further comprising:
encrypting the module key using an initiation sequence, yielding an encrypted module key; and
storing the encrypted module key and the initiation sequence;
wherein the step of decrypting the encrypted software module comprises decrypting the encrypted module key.

13. A computer device for enabling an encrypted software module in a container file for a software application, the computer device comprising:
a processor; and
a memory storing instructions that, when executed by the processor, cause the computer device to:
obtain an encrypted software module from a container file;
transmit a key request over a network connection to a remote key provider, the key request comprising an identifier of the encrypted software module;
receive a module key from the key provider;
decrypt the encrypted software module, yielding a decrypted software module; and
load the decrypted software module from restricted access memory of the computer device to enable its execution.

14. The computer device according to claim 13, further comprising instructions that, when executed by the processor, cause the computer device to:
encrypt the module key using an initiation sequence, yielding an encrypted module key; and
store the encrypted module key and the initiation sequence;
wherein the instructions to decrypt comprise instructions that, when executed by the processor, cause the computer device to decrypt the encrypted module key.

15. A computer program for enabling an encrypted software module in a container file for a software application, the computer program comprising computer program code which, when run on a computer device causes the computer device to:
obtain an encrypted software module from a container file;
transmit a key request over a network connection to a remote key provider, the key request comprising an identifier of the encrypted software module;
receive a module key from the key provider;
decrypt the encrypted software module, yielding a decrypted software module; and
load the decrypted software module from restricted access memory of the computer device to enable its execution.

16. A computer program product comprising a computer program according to claim 15 and a computer readable means on which the computer program is stored.
